(19) United States
(12) Patent Application Publication
(10) Pub. No.: US 2010/0016768 A1
(43) Pub. Date: Jan. 21, 2010

(54) STRUCTURE OF VIBRATING AND ROLLING MASSAGE DEVICE

(76) Inventor: Jung-Jen Liu, Taipei City (TW)

Correspondence Address: LEONG C LEI, PMB # 1008, 1867 YGNACIO VALLEY ROAD, WALNUT CREEK, CA, 94598, US

(21) Appl. No.: 12/470,497

(22) Filed: May 22, 2009

(30) Foreign Application Priority Data
Jul. 16, 2008 (TW) 097212664

(51) Int. Cl. A61H 1/00; A61H 7/00; A61H 15/00

(52) U.S. Cl. 601/46; 601/134; 601/115

(57) ABSTRACT

A vibrating and rolling massage device is wearable on a limb of a user in order to allow the user to carry out massage operation with rolling of the massage device and to provide massage effect simultaneously on the limb wearing the massage device and a part of a human body on which the palm wearing the massage device is positioned. Further, a vibration motor that generates vibration for carrying out massage operation is provided in such a way that the vibration motor is accommodated in a motor holder that can be releasably mounted/dismounted in a tool free manner so that the vibration motor can be selectively set at a position desired by the user.

### TECHNICAL FIELD OF THE INVENTION

The present invention generally relates to a massage device, and particularly to a rolling massage device that can be worn on a limb of a human body.

### DESCRIPTION OF THE PRIOR ART

Massages are an operation that applies suitable pressure to human body for enhancing blood circulation, relaxing muscles, and releasing internal pressure. However, for an amateur person, application of pressure properly by using his or her body's strength to perform massage is difficult. It is often that the muscles of hands that perform the massage operation feel sour and hurt or forceless due to performance of massage for excessive time or with improper posture or due to over stretching of muscles that have not been exercised for a long time.

Various hand-held massage devices, which function to assist a user to perform massage operations, are available in the market and such devices allow a user to perform massage operations in an effort-saved manner. Examples include a massage bar and a massage roller.

However, the known hand-held massage devices are often constructed in such a way that a massage operator cannot directly feel the body structure of a massaged person, making the massage operation performed in a stiff and blunt manner. Further, the hand-held massage device must be held by a hand or two hands of the massage operator and this may leads to sourness and pain of palm and wrist of the operator. Sometimes, abrasion may occur in the palm of the operator if the posture of holding the massage device is improper.

In view of these problems, the present invention aims to provide a vibrating and rolling massage device that can be worn by an operator to allow the operator to more closely handle the contour of the body on which massage is performed and thereby carry out the massage operation in the most effort saved manner.

### SUMMARY OF THE INVENTION

A primary objective of the present invention is to provide a structure of a rolling massage device, which can be worn on a limb of an operator so as to make the performance of massage operation easy and convenient.

To achieve the above objective, the present invention provides a rolling massage device comprising a pliable body, which comprises a massage pad and at least one fastening belt set for fastening the massage pad to a limb of a user, the massage pad having a surface, which forms a plurality of massage bosses, and an opposite surface, on which a plurality of massage spheres is rotatably mounted; at least one positioning section, which comprises a plurality of circumferentially arranged concentric arc positioning slots, which have an end forming an expanded hole; a motor holder, which comprises a plurality of T-shaped positioning pegs corresponding to and engageable with the arc positioning slots to secure the motor holder to the positioning section through rotation thereof; and a vibration motor, which is arranged on the motor holder; and a massage cap, which houses the motor holder and forms a plurality of massage beads.

Opposite side edges of the massage pad project sideways to form side wings so that the massage pad generally forms a mountain-shaped contour corresponding to a palm of a user, or alternatively, the massage pad can be made in the form of a figure-8 shaped contour to correspond to the palm of the user.

The motor holder can comprise batteries set therein to supply electricity required for the operation of the vibration motor. Or alternatively, the motor holder is provided with a power port to which an external power source can be connected for supply of electricity needed for the operation of the vibration motor.

As compared to the known devices, the present invention provides a rolling and vibrating massage device that can be worn on a limb of a user to be operated by the user for carrying out massage operation in an easy and effort-saved manner and to allow massage operation to be simultaneously carried out on the limb that wears the massage device and a part of a human body on which the limb that wears the massage device is positioned. An apparently improved effect of massage over the known hand-held massage devices is thus provided. Further, the vibration motor that generates the vibration for carrying out massage operation is accommodated in a motor holder that can be releasably mounted/dismounted in a tool free manner so that the vibration motor can be selectively set at a position desired by the user. The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a massage device in accordance with a first embodiment of the present invention.

FIG. 2 is a perspective view of the massage device in accordance with the first embodiment of the present invention.

FIG. 3 is a cross-sectional view of the massage device in accordance with the first embodiment of the present invention.

FIG. 4 is a perspective view showing a different way of use of the massage device in accordance with the first embodiment of the present invention.

FIG. 5 is a plan view of a massage device in accordance with a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention will now be explained with reference to the drawings.

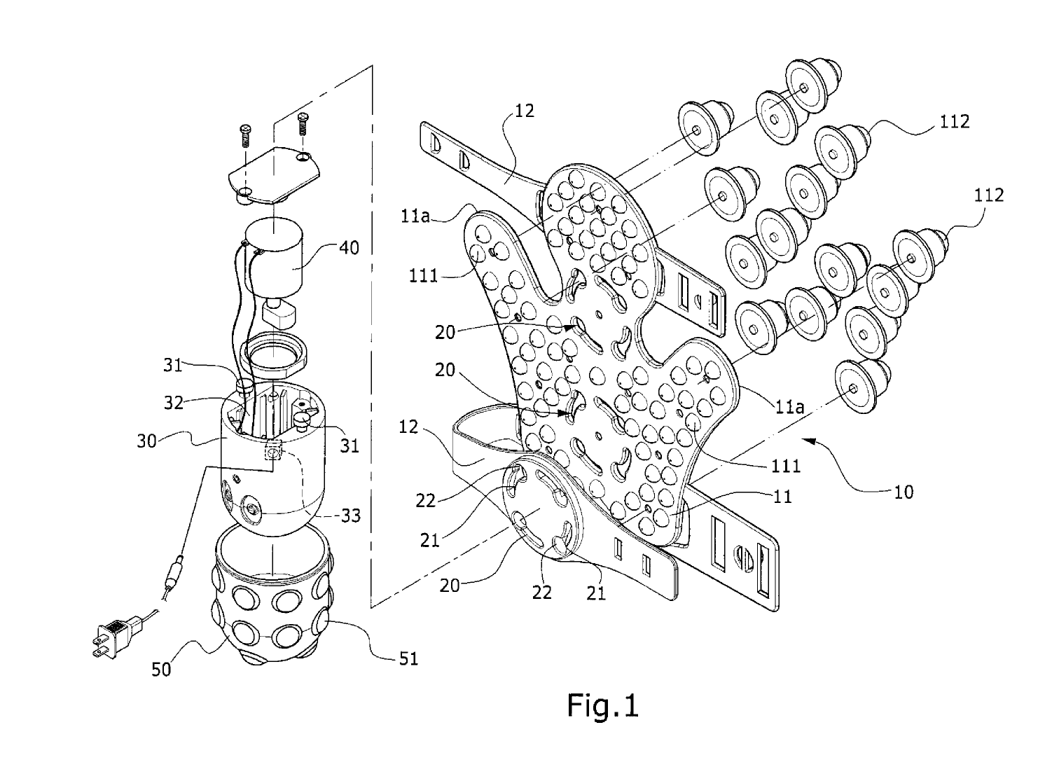

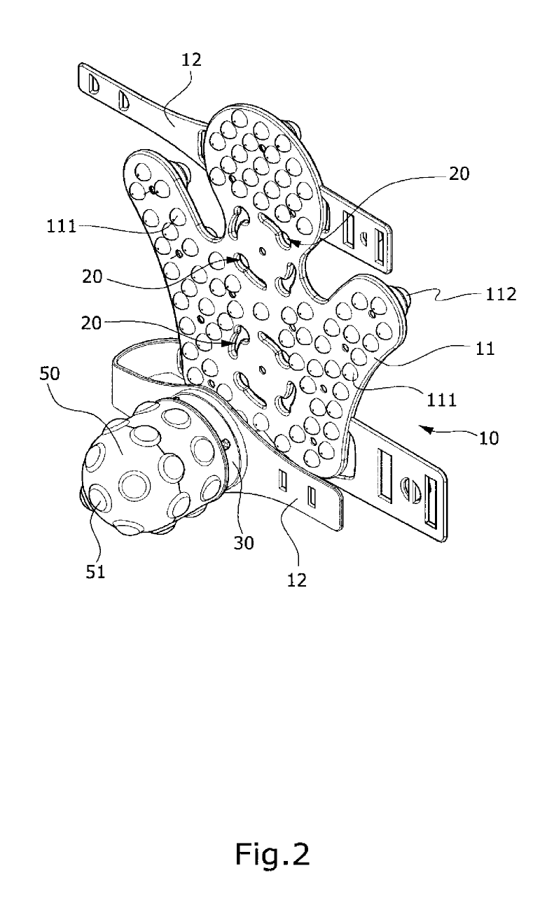

As shown in FIG. 1, which is an exploded view of a first embodiment of the present invention, a rolling massage device in accordance with the first embodiment of the present invention comprises a pliable body 10, at least one positioning section 20 formed in the pliable body 10, a motor holder 30 formed on the positioning section 20, a vibration motor 40 received in the motor holder 30, and a massage cap 50 fit over the motor holder 30, of which an assembled perspective view is illustrated in FIG. 2.

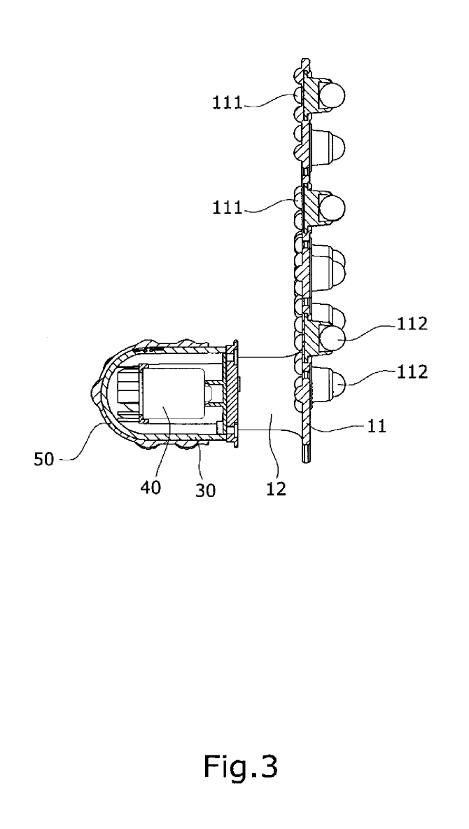

Referring to FIGS. 1 and 3, of which FIG. 3 is a cross-sectional view of the first embodiment of the present invention, the pliable body 10 comprises a massage pad 11 and at least one belt set 12 for fastening the massage pad 11 to a user's limb. (In the embodiment illustrated, two sets of fastening belts 12 extending from lateral edges of the massage pad 11.) The massage pad 11 has a surface, which forms a plurality of massage bosses 111, and an opposite surface, on which a plurality of massage spheres 112 is rotatably mounted. In the instant embodiment, opposite side edges of the massage pad 11 project sideways to form side wings 11a so that the massage pad 11 generally forms a mountain-shaped contour corresponding to a palm of the user.

The positioning section 20 comprises a plurality of circumferentially arranged concentric arc positioning slots 21 and the positioning slots 21 have an end forming an expanded hole 22. In the instant embodiment, three positioning sections 20 are provided, wherein one positioning section 20 is formed in one fastening belt set 12 of the pliable body 10, while the remaining two positioning sections 20 are formed in the massage pad 11.

The motor holder 30 comprises a plurality of T-shaped positioning pegs 31 corresponding to and engageable with the arc positioning slots 21, whereby the motor holder 30 can be rotated to get into engagement with and thus fixed to the positioning section 20. (In the embodiment illustrated, the motor holder 30 is attached to the one of the positioning sections 20 that is formed in the fastening belt set 12.) To assemble, the T-shaped positioning pegs 31 are fit into the arc positioning slots 21 through the expanded holes 22 thereof and are then moved toward a narrowed end of the positioning slots 21 so as to secure the motor holder 30. To dismount, the T-shaped positioning pegs 31 are moved away from the narrowed end toward the expanded hole 22 for disengagement from the arc positioning slot 21. With this arrangement, the motor holder 30 can be efficiently mounted to and/or dismounted from the positioning sections 20 in a tool-free manner.

The vibration motor 40 is received in an accommodation chamber 32 of the motor holder 30. The motor holder 30 can comprise batteries (not shown) set therein to supply electricity required for the operation of the vibration motor 40. Or alternatively, the motor holder 30 is provided with a power port 33 to which an external power source (not shown) can be connected for supply of electricity needed for the operation of the vibration motor 40.

The massage cap 50 comprises a pliable and soft plastic or rubber enclosure having a surface forming a plurality of massage beads 51. The massage cap 50 functions to house the motor holder 30 and also provides a massage function by means of the massage beads 51 formed on the surface thereof.

To use, a massage operator wears the massage device by surrounding and fastening the two fastening belt sets 12 around his or her limb. For example, one of the belt sets 12 can be put to surround fingers of a hand of the operator and the other belt set 12 wraps around the wrist of the hand, whereby the massage pad 11 is positioned to correspond to the palm of the hand of the operator.

When the vibration motor 40 is put into operation, the palm of the operator can feel the vibration caused by the motor and the palm of the operator is subjected to massage by the massage bosses 111. Further, the massage operator may apply massage to his or her own body or other person by positioning and rolling the massage spheres 112 on his or her own body or the other person.

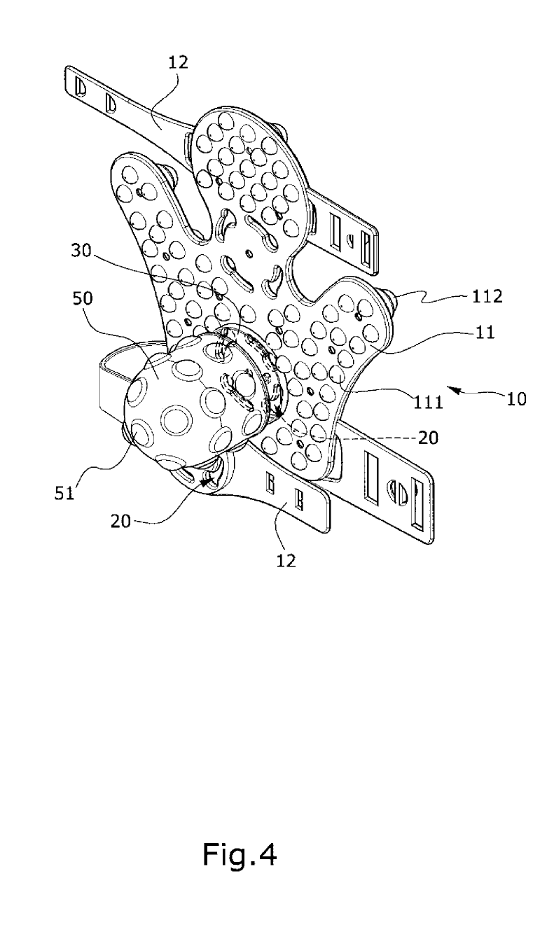

FIG. 4 shows a different way of using the massage device of the first embodiment of the present invention, wherein the motor holder 30 is mounted to one of the positioning sections 20 formed in the massage pad 11 and a massage operator may hand hold the massage cap 50 to roll the massage device for operation or the massage operator may place the massage device on a fixture surface, such as a desk top or a bed, and then put his or her palm on the top end of the massage cap 50 in order to receive massage operation from the massage beads 51 of the massage cap 50 applied to the palm or other parts of the body.

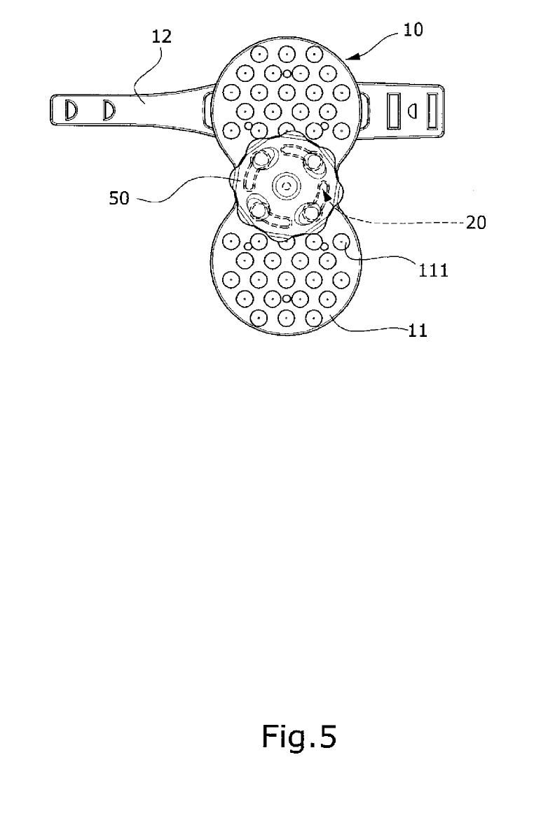

Referring to FIG. 5, which shows a plan view of a massage device in accordance with a second embodiment of the present invention, the operation and the use of the second embodiment are substantially identical to those of the first embodiment, but the massage pad 11 of the second embodiment is in the form of a figure-8 shape, which corresponds to the contour of a user's palm, but occupies a less amount of space so as to easy to carry outdoors.

In the previous description associated with the first and second embodiments, the present invention provides a massage device that can be worn on a limb of a user to carry out massage operation through vibration so that the massage operation can be carried out in an easier and more effort-saved manner and massage operation can simultaneously carried out on the limb that wears the massage device and a part of a human body on which the limb that wears the massage device is positioned. An apparently improved effect of massage is thus provided. Further, the vibration motor 40 that generates the vibration for carrying out massage operation is accommodated in a motor holder 30 that can be releasably mounted/dismounted in a tool free manner so that the vibration motor 40 can be selectively set at a position desired by the user.

It is understood that the description given above associated with components and/or construction of the massage device of the present invention, such as the fastening belt sets 12, the massage bosses 111, the massage spheres 112, and the massage cap 50, are only illustrative of a preferred embodiment of the present invention and are not set to limit the scope of the present invention that is only defined by the appended claims.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A vibrating and rolling massage device comprising:
a pliable body, which comprises a massage pad and at least one fastening belt set adapted to fasten the massage pad to a limb of a user, the massage pad having a surface, which forms a plurality of massage bosses, and an opposite surface, on which a plurality of massage spheres is rotatably mounted; and
at least one positioning section, which is composed of a plurality of circumferentially arranged concentric arc positioning slots formed in the pliable body, the positioning slots having an end forming an expanded hole.

2. The vibrating and rolling massage device according to claim 1, wherein the positioning section is formed in the fastening belt set.

3. The vibrating and rolling massage device according to claim 1, wherein the positioning section is formed in the massage pad.

4. The vibrating and rolling massage device according to claim 1, wherein the massage pad has opposites sides from which side wings project sideways to form a mountain like shape.

5. The vibrating and rolling massage device according to claim 1, wherein the massage pad forms a digit-8 shape.

6. The vibrating and rolling massage device according to claim 1, wherein the positioning section further comprises a motor holder, which forms a plurality of T-shaped positioning pegs corresponding to and engageable with the arc positioning slots to secure the motor holder to the positioning section through rotation thereof; and a vibration motor coupled to the motor holder.

7. The vibrating and rolling massage device according to claim 6, wherein the motor holder is housed by a massage cap that forms a plurality of massage beads on its surface.

8. The vibrating and rolling massage device according to claim 6, wherein the motor holder comprises a battery set therein to supply electricity to the vibration motor.

9. The vibrating and rolling massage device according to claim 6, wherein the motor holder comprises a power port adapted to connect to an external power source for supplying electricity to the vibration motor.
